(19) United States
(12) Patent Application Publication
(10) Pub. No.: US 2015/0149181 A1
(43) Pub. Date: May 28, 2015

(54) METHOD AND SYSTEM FOR VOICE SYNTHESIS

(71) Applicants: CONTINENTAL AUTOMOTIVE FRANCE, Toulouse (FR); CONTINENTAL AUTOMOTIVE GmbH, Hannover (DE)

(72) Inventor: Vincent Delahaye, Gallardon (FR)

(21) Appl. No.: 14/411,952

(22) PCT Filed: Jul. 2, 2013
(86) PCT No.: PCT/EP2013/001928

§ 371 Date: Dec. 30, 2014

(30) Foreign Application Priority Data
Jul. 6, 2012 (FR) 1256507

(51) Int. Cl. G10L 13/08; G10L 13/06

(52) U.S. Cl. CPC G10L 13/08; G10L 13/06; G10L 13/086
USPC 704/260

(57) ABSTRACT

Method and system for generating audio signals (9) representative of a text (3) to be converted, the method includes the steps of:
providing a database (1) of acoustic units,
identifying a list of pre-calculated expressions (10), and recording, for each pre-calculated expression, an acoustic frame (7) corresponding to it being pronounced,
decomposing, by virtue of correlation calculations, each recorded acoustic frame into a sequenced table (5) including a series of acoustic unit references modulated by amplitude (α(i)A) and temporal (α(i)T) form factors ,
identifying in the text the pre-calculated expressions and decomposing the rest (12) into phonemes,
inserting in place of each pre-calculated expression the corresponding sequenced table, and
preparing a concatenation of acoustic units (19) according to the text to be converted.

The present invention relates to methods and systems for voice synthesis. These methods and systems for voice synthesis may, in particular but not exclusively, be used in a navigation aid system carried onboard a vehicle.

In the art, the use of voice synthesis systems is known that are based on the selection of acoustic units starting from a database of synthetic acoustic units. The audio signals produced by these systems exhibit a rather metallic sound and are quite far from the natural voice of a speaker, which is not desirable.

Also known in the art is the use of voice synthesis systems based on the selection of recorded acoustic sequences from a database of recorded acoustic frames.

However, these systems suffer from two drawbacks: the vocabulary is limited to the words having been the object of a recording and the size of memory used by these recordings is very significant.

According to the prior art, another known solution is to combine the two approaches in a certain manner, such as for example in the document US 2011/218809. However, it seemed to be desirable to improve the combination of the two approaches, in order to reduce the memory size needed for the representation of the recordings while at the same time maintaining the quality and the natural aspect of the emitted audio signals.

For this purpose, a method is provided for generating a set of sound signals representative of a text to be converted into audio signals intelligible to a user, comprising the following steps:
a) supply, in a database, a set of acoustic units, each acoustic unit corresponding to the synthetic acoustic formation of a phoneme or of a diphoneme, said database comprising acoustic units corresponding to the whole set of phonemes or diphonemes used for a given language,
b) identify a list of pre-calculated expressions, each pre-calculated expression comprising one or more complete word texts,
c) record, for each pre-calculated expression, an acoustic frame corresponding to the pronouncing of said pre-calculated expression,
d) decompose, by virtue of cross-correlation calculations, each recorded acoustic frame into a sequenced table comprising a series of acoustic unit references from the database modulated at least by one amplitude form factor and by one temporal form factor,
e1) search through a text to be converted, identify at least a first portion of the text corresponding to at least one pre-calculated expression and decompose into phonemes at least a second portion of the text which does not comprise a pre-calculated expression,
e2) insert in place of each pre-calculated expression the equivalent recording from the sequenced table, and select, for each phoneme of the second portion of the text, one acoustic unit from the database,
f) prepare a concatenation of acoustic units corresponding to the first and second portions of text, in a manner ordered according to the text to be converted,
g) generate the audio signals corresponding to said concatenation of acoustic units.

By virtue of these dispositions, any given text may be converted into audio signals by making best use of high quality recordings of the most used pre-calculated expressions, and this is achieved using a memory space of limited size as resource required at the time of the conversion of the text. The audio signals reproduced are thus of a quality close to the natural voice, notably as regards the first portions of text corresponding to the pre-calculated expressions.

In various embodiments of the method according to the invention, it may potentially be required to furthermore make use of one and/or the other of the following dispositions:
the steps b), c) and d) may be carried out offline in the course of preparatory works, so that the whole set of the acoustic frames of the pre-calculated expressions is stored and processed in offline mode on a conventional computer;
the memory space occupied by the sequenced tables may be at least five times smaller than the memory space occupied by the acoustic frames of the pre-calculated expressions, so that the memory space required in the onboard equipment is much smaller than the memory space needed for storing the acoustic frames of the pre-calculated expressions;
the memory space occupied by the sequenced tables may be less than 10 Megabytes, whereas the amount of memory occupied by the acoustic frames of the pre-calculated expressions is greater than 100 Megabytes; accordingly, the use of flash memories in the onboard equipment can be limited and this allows flash memories of limited size to be used;
the acoustic units may be diphones, so that the quality of the concatenations is improved;
said method may be implemented in a navigation aid unit carried onboard a vehicle.

The invention is also aimed at a device for generating a set of sound signals representative of a text to be converted into audio signals intelligible to a user, the device comprising:
an electronic control unit comprising a voice synthesis engine,
a database, comprising a set of acoustic units corresponding to the whole set of phonemes or diphonemes used for a given language,
a list of pre-calculated expressions, each pre-calculated expression comprising one or more complete word texts,
at least one sequenced table, which comprises, for one pre-calculated expression, a series of acoustic unit references from the database modulated at least by one amplitude form factor (α(i)A) and by one temporal form factor (α(i)T), said electronic unit being designed to:
   e1) search through a text to be converted, identify at least a first portion of the text corresponding to at least one pre-calculated expression and decompose into phonemes at least one second portion of the text which does not comprise a pre-calculated expression,
   e2) insert in place of each pre-calculated expression the equivalent recording from the sequenced table, and select, for each phoneme of the second portion of the text, one acoustic unit from the database,
   f) prepare a concatenation of acoustic units corresponding to the first and second portions of text, in a manner ordered according to the text to be converted,
   g) generate the audio signals corresponding to said concatenation of acoustic units.

In various embodiments of the system according to the invention, it may potentially be required to furthermore make use of one and/or the other of the dispositions already described relating to the method hereinabove.

Other aspects, aims and advantages of the invention will become apparent upon reading the following description of one of its embodiments, presented by way of non-limiting example. The invention will also be better understood with regard to the appended drawings in which:

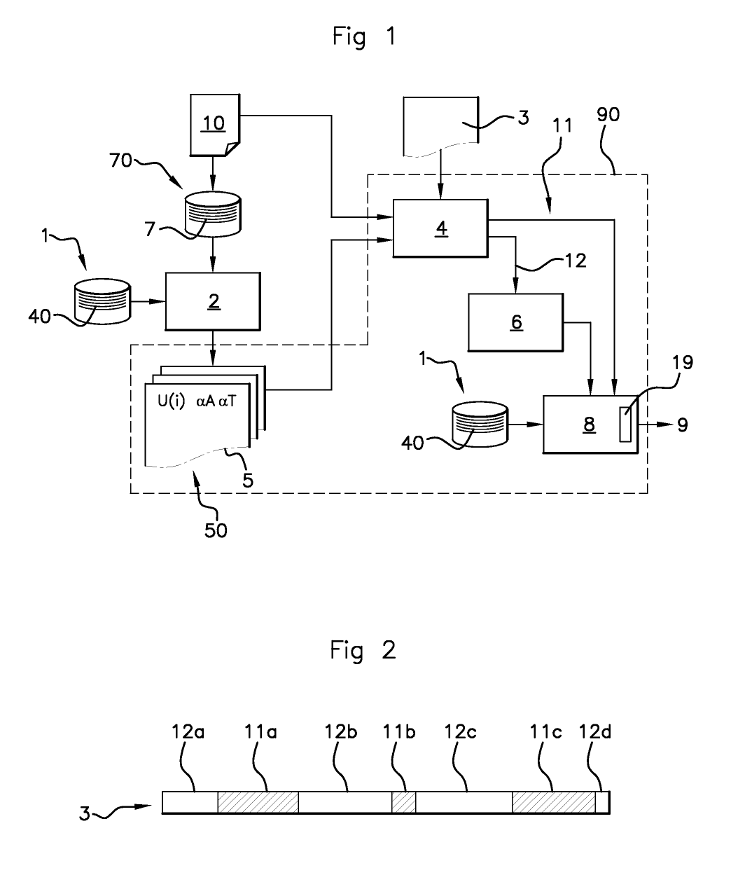

FIG. 1 shows schematically a device and a method implemented according to the invention,

FIG. 2 shows schematically a text to be converted, and

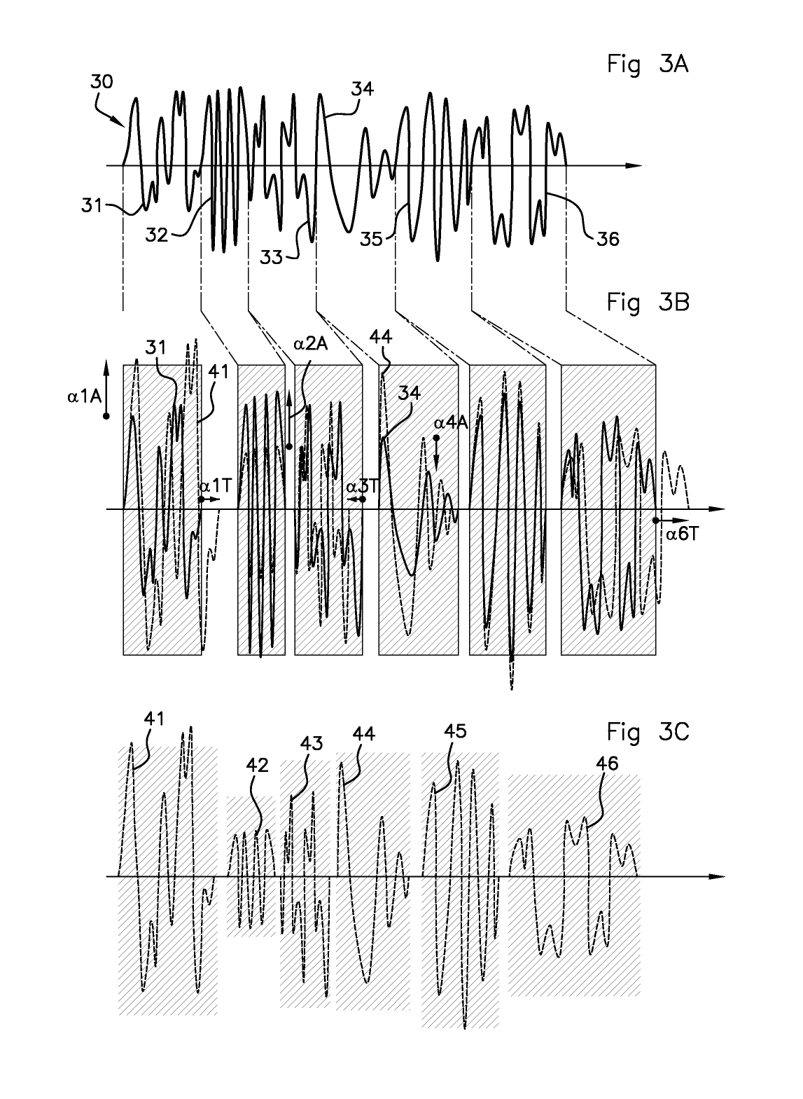

FIGS. 3A, 3B and 3C show recorded acoustic signals and their processing.

In the various figures, the same references denote identical or similar elements.

Referring to FIG. 1, the method uses:
a database 1, comprising a set of acoustic units corresponding to the whole set of phonemes used for a given language, each acoustic unit 40 corresponding to the synthetic acoustic generation of a phoneme or of a diphoneme,
a list of pre-calculated expressions 10 which contains for example the expressions the most often used in the voice synthesis system in question,
a text 3 to be converted into audio signals intelligible to a user, where said text 3 may contain one or more expressions belonging to the above-mentioned list of pre-calculated expressions 10, and these pre-calculated expressions will be treated as exceptions.

The text 3 at the input of the voice synthesis system can comprise mainly words, but it may also contain numbers, acronyms (which will be treated as exceptions) and any written representation.

The list of pre-calculated expressions 10 may comprise single words or phrases. Preferably, the words, phrases or bits of phrase the most commonly used will be chosen in the text to be converted in the voice synthesis system in question.

According to the present method, each expression belonging to the list of pre-calculated expressions 10 is pronounced by a reference speaker and the signals representing the acoustic frame 7 corresponding to the pronouncing of said pre-calculated expression are recorded. The whole set of the acoustic frames 7, corresponding to the natural voice, is contained in an acoustic database 70.

An offline analysis unit 2 is provided for processing each acoustic frame 7 of the acoustic database 70. The processing will be explained in detail hereinbelow.

For each acoustic frame 7, the offline analysis unit 2 generates a sequenced table 5 comprising a series of acoustic unit references 40 from the database 1, modulated at least by one amplitude form factor α(i)A and by one temporal form factor α(i)T. More precisely, each row of the sequenced table 5 comprises, on the one hand, a reference or an identifier U(i) of an acoustic unit 40 and, on the other hand, one or more form factors (α(i)A, α(i)T . . . ) to be applied to this acoustic unit 40. These form factors (α(i)A, α(i)T . . . ) comprise in particular an amplitude form factor α(i)A and a temporal form factor α(i)T.

An electronic control unit 90, for example carried onboard a vehicle, comprises an analysis block 4 designed to analyze the content of a text 3.

The analysis performed by the analysis block 4 of the electronic control unit 90 allows the expressions belonging to the list of pre-calculated expressions 10 to be identified; these constitute one or more parts referred to as first portions of text 11, which will be processed as exceptions for the voice synthesis step.

As illustrated in FIG. 2, the text 3 comprises three pre-calculated expressions 11a, 11b, 11c and comprises four other portions of text 12a, 12b, 12c, 12d.

In this case, the analysis block 4 of the electronic control unit 90 is configured for identifying within the initial text 3, by removing the first portions of text 11, the other portions of text 12a, 12b, 12c, 12d which are lacking any pre-calculated expressions. These other portions of text 12a, 12b, 12c, 12d form one or more second portions of the text 12 without a pre-calculated expression. The second portions of the text 12 are therefore complementary to first portions of text 11.

The analysis block 4 is additionally designed to select the appropriate sequenced table 5 from amongst the set 50 of sequenced tables 5 corresponding to the above-mentioned acoustic frames 7.

A conversion block 6 is configured for converting into phonemes the second portions of the text 12. In addition, the conversion block 6 selects within the database 1 the best acoustic unit 40 for each phoneme in question.

A synthesis block 8 acquires at its input the output of the conversion block 6 relating to the second portions of text 12 and the output of the analysis block 4 relating to first portions of text 11.

The synthesis block 8 processes these inputs so as to prepare a concatenation of acoustic units 19 corresponding to the first and second portions of text 11, 12, in a manner ordered according to the text 3 to be converted. The synthesis block 8 can thus subsequently generate at its output a set of audio signals 9 representative of the text 3 to be converted.

As indicated hereinabove, the offline analysis unit 2 carries out a processing operation on each acoustic frame 7 of the acoustic database 70. This processing is illustrated in FIGS. 3A, 3B, 3C and comprises the operations described hereinafter.

A cross-correlation calculation is carried out by taking, on one side, the start of the signal 30 representative of the acoustic frame 7 and, on the other side, each acoustic unit 40 of the database 1. An acoustic unit 41 having the closest similarity with the start of the acoustic frame 7 is thus chosen. The similarity includes the potential application of form factors, in particular an amplitude form factor α1A and a temporal form factor α1T. Based on this first result, the sequenced table 5 is initialized with the identification U(1) of the acoustic unit 41 accompanied by its amplitude and temporal form factor α1A, α1T. Subsequently, the start of the signal 31 corresponding to the chosen first acoustic unit 41 is subtracted from the acoustic frame 7 which is equivalent to shifting by the same amount the frame start pointer.

Subsequently, the cross-correlation calculation is iterated in order to choose a second acoustic unit U(2), to which are also applied its amplitude and temporal form factors α2A, α2T.

The process subsequently continues by iteration until arriving at the end of the signal 30 representative of the recorded acoustic frame 7.

As illustrated in FIGS. 3A, 3B, 3C, the first part 31 of the frame leads to selecting the acoustic unit 41, the second part 32 of the frame leads to selecting the acoustic unit 42, the third part 33 of the frame leads to selecting the acoustic unit 43, the fourth part 34 of the frame leads to selecting the acoustic unit 44, the fifth part 35 of the frame leads to selecting the acoustic unit 45, and the sixth part 36 of the frame leads to selecting the acoustic unit 46.

Each of the acoustic units has amplitude and temporal form factors α(i)A, α(i)T applied to it which are specific to it. It is noted that the use of the amplitude form factor α(i)A can lead to increasing or to reducing the intensity of the signal and the use of the temporal form factor α(i)T can lead to expanding or contracting the signal over time, in order to reduce the difference between the frame part of the original signal 30 and the signal from the selected acoustic unit to which said form factors α(i)A, α(i)T are applied.

Thus, the correspondence is determined between the pre-calculated expression and a succession of acoustic units having said form factors, stored in the form of the sequenced table 5.

By virtue of the above, the audio signals which will be generated later for the pre-calculated expression, based on the succession of the acoustic units with their form factors α(i)A, α(i)T, will yield a generated voice having a small difference with the recorded original natural voice 7.

Thus, one example of method according to the invention comprises the following steps:
a) supply a database 1,
b) identify the list of pre-calculated expressions 10,
c) record, for each pre-calculated expression, an acoustic frame 7 corresponding to it being pronounced,
d) decompose, by virtue of cross-correlation calculations, each recorded acoustic frame 7 into a sequenced table 5,
e1) search through a text to be converted, identify the first portions of the text 11 corresponding to the pre-calculated expressions and decompose into phonemes the second portions of the text 12,
e2) insert in place of each pre-calculated expression the equivalent recording from the sequenced table 5, and select, for each phoneme of the second portion of the text 12, one acoustic unit from the database 1,
f) prepare an ordered concatenation of acoustic units 19 corresponding to the text to be converted,
g) generate the audio signals 9 corresponding to said concatenation of acoustic units 19.

Advantageously, the memory space occupied by the set 50 of the sequenced tables 5 is at least five times smaller than the memory space occupied by the set 70 of the acoustic frames 7 of the pre-calculated expressions. In one particular case, the memory space occupied by the sequenced tables 5 is less than 10, whereas the amount of memory occupied by the acoustic frames of the pre-calculated expressions can be greater than 100 Megabytes.

It will be understood that the set 50 of the sequenced tables 5 is stored in the onboard equipment, for example in a flash memory of reasonable size and low cost, whereas the set 70 of the acoustic frames 7 of the pre-calculated expressions does not need to be stored in the onboard equipment. On the contrary, the set 70 of the acoustic frames 7 of the pre-calculated expressions is stored and processed offline on a conventional computer.

II is to be noted that the acoustic units 40 may represent phonemes or diphones, a diphone being an association of two semi-phonemes.

Advantageously, the voice synthesis system can process any given text 3 of a given language because the database 1 contains all the phonemes of said given language. For the most often used expressions, which form part of the list of pre-calculated expressions 10, a very satisfactory quality of audio signals, close to the natural voice, is obtained.

1. A method for generating a set of sound signals (9) representative of a text (3) to be converted into audio signals intelligible to a user, comprising the following steps:
a) supply, in a database (1), a set of acoustic units, each acoustic unit corresponding to the synthetic acoustic formation of a phoneme or of a diphoneme, said database (1) comprising acoustic units corresponding to the whole set of phonemes or diphonemes used for a given language,
b) identify a list of pre-calculated expressions (10), each pre-calculated expression comprising one or more complete word texts,
c) record, for each pre-calculated expression, an acoustic frame (7) corresponding to the pronouncing of said pre-calculated expression,
d) decompose, by virtue of cross-correlation calculations, each recorded acoustic frame into a sequenced table (5) comprising a series of acoustic unit references from the database modulated at least by one amplitude form factor (α(i)A) and by one temporal form factor (α(i)T),
e1) search through the text (3) to be converted, identify at least a first portion of the text (11) corresponding to at least one pre-calculated expression and decompose into phonemes at least a second portion of the text (12) which does not comprise a pre-calculated expression,
e2) insert in place of each pre-calculated expression the equivalent recording from the sequenced table (5), and select, for each phoneme of the second portion of the text (12), one acoustic unit from the database (1),
f) prepare a concatenation of acoustic units (19) corresponding to the first and second portions of text (11, 12), in a manner ordered according to the text (3) to be converted,
g) generate the audio signals (9) corresponding to said concatenation of acoustic units.

2. The method as claimed in claim 1, wherein the steps b), c) and d) are carried out offline during preparatory works.

3. The method as claimed in claim 1, wherein the memory space occupied by the sequenced tables (5) is at least five times smaller than the memory space occupied by the acoustic frames of the pre-calculated expressions.

4. The method as claimed in claim 1, wherein the memory space occupied by the sequenced tables (5) is less than 10 Megabytes, whereas the amount of memory occupied by the acoustic frames of the pre-calculated expressions is greater than 100 Megabytes.

5. The method as claimed in claim 1, wherein the acoustic units are diphones.

6. The method as claimed in claim 1, wherein said method is implemented within a navigation aid unit carried onboard a vehicle.

7. A device for generating a set of sound signals (9) representative of a text (3) to be converted into audio signals intelligible to a user, the device comprising:
an electronic control unit (90) comprising a voice synthesis engine,
a database (1), comprising a set of acoustic units corresponding to the whole set of phonemes or diphonemes used for a given language,
a list of pre-calculated expressions (10), each pre-calculated expression comprising one or more complete word texts,
at least one sequenced table (5), which comprises, for one pre-calculated expression, a series of acoustic unit references from the database (1) modulated at least by one amplitude form factor (α(i)A) and by one temporal form factor (α(i)T),
said electronic unit being designed to:
e1) search through the text (3) to be converted, identify at least a first portion of the text (11) corresponding to at least one pre-calculated expression and decompose into phonemes at least one second portion of the text (12) which does not comprise a pre-calculated expression,
e2) insert in place of each pre-calculated expression the equivalent recording from the sequenced table (5), and select, for each phoneme of the second portion of the text (12), one acoustic unit from the database (1),
f) prepare a concatenation of acoustic units corresponding to the first and second portions of text (11, 12), in a manner ordered according to the text (3) to be converted,
g) generate the audio signals (9) corresponding to said concatenation of acoustic units.

8. The device as claimed in claim 7, further comprising an offline analysis unit (2) designed to:
d) decompose, by virtue of cross-correlation calculations, each recorded acoustic frame corresponding to a pre-calculated expression from the list of pre-calculated expressions (10), into a sequenced table (5) comprising a series of acoustic units from the database modulated at least by one amplitude form factor (α(i)A) and by one temporal form factor (α(i)T).

9. The device as claimed in claim 8, wherein the memory space occupied by the sequenced tables (5) is at least five times smaller than the memory space occupied by the acoustic frames of the pre-calculated expressions, preferably wherein the memory space occupied by the sequenced tables (5) is less than 10 Megabytes, whereas the amount of memory occupied by the acoustic frames of the pre-calculated expressions is greater than 100 Megabytes.

10. The display device as claimed in claim 7, wherein the electronic control unit (90) is a navigation aid unit carried onboard a vehicle.

11. The method as claimed in claim 2, wherein the memory space occupied by the sequenced tables (5) is at least five times smaller than the memory space occupied by the acoustic frames of the pre-calculated expressions.

12. The method as claimed in claim 2, wherein the memory space occupied by the sequenced tables (5) is less than 10 Megabytes, whereas the amount of memory occupied by the acoustic frames of the pre-calculated expressions is greater than 100 Megabytes.

13. The method as claimed in claim 3, wherein the memory space occupied by the sequenced tables (5) is less than 10 Megabytes, whereas the amount of memory occupied by the acoustic frames of the pre-calculated expressions is greater than 100 Megabytes

14. The display device as claimed in claim 8, wherein the electronic control unit (90) is a navigation aid unit carried onboard a vehicle.
